(19) United States
(12) Patent Application Publication
(10) Pub. No.: US 2006/0013624 A1
(43) Pub. Date: Jan. 19, 2006

(54) Image-fixing apparatus, and, image-forming apparatus

(76) Inventors: Shigeo Kurotaka, Sagamihara-shi (JP); Masami Tomita, Numazu-shi (JP); Katsuhiro Echigo, Asaka-shi (JP); Takashi Fujita, Yokohama-shi (JP); Toshihiko Baba, Tokyo (JP); Hisashi Kikuchi, Kawasaki-shi (JP); Hiroyuki Kunii, Yokohama-shi (JP); Atsushi Nakafuji, Tokyo (JP); Yukimichi Someya, Saitama-shi (JP); Kohji Ue, Kawasaki-shi (JP)

Correspondence Address: HARNESS, DICKEY & PIERCE, P.L.C., P.O. BOX 8910, RESTON, VA, 20195, US

(21) Appl. No.: 11/178,275

(22) Filed: Jul. 12, 2005

(30) Foreign Application Priority Data
Jul. 12, 2004 (JP) 2004-204420

(51) Int. Cl. G03G 15/20

(52) U.S. Cl. 399/329

(57) ABSTRACT

An image-fixing apparatus including a fixing belt; a fixing member; a pressure member; and a heating source, wherein the fixing belt is heated by the heating source, wherein the fixing member is brought into pressure contact with the pressure member via the fixing belt to form a nip and a paper carrying an unfixed toner is allowed to pass through the nip, thereby fixing the unfixed toner on the paper, and wherein the toner to be used includes a binder resin, a colorant, and a releasing agent, and wherein the toner has a ½ flown-out temperature of 115° C. to 145° C. and has a storage elastic modulus (G′) at 190° C. of 200 Pa or more.

### BACKGROUND OF THE INVENTION

1. Field of the Invention

The present invention relates to an image-fixing apparatus and to an image-forming apparatus, particularly relates to the image-fixing apparatus and to the image-forming apparatus where a fixing member is brought into pressure contact with a pressure member to form a nip and a paper carrying an unfixed toner is allowed to pass through the nip, thereby fixing the unfixed toner on the paper, and which comprises an induction heating source which heats a fixing belt in the region other than the nip.

2. Description of the Related Art

As the above-mentioned image-forming apparatus, office automation (OA) equipments such as laser beam printers, digital copiers, plain paper faxes, etc. are used.

As the image-forming apparatus, the following image-fixing apparatus for an electrophotographic apparatus is known. Specifically, the image-fixing apparatus for an electrophotographic apparatus is characterized in that an endless fixing belt comprising a release layer on the surface of the main body of the belt is spanned around a fixing roller and a heating roller, a pressure roller which presses the fixing roller from downward via the fixing belt is arranged to form a nip portion between the fixing belt and the pressure roller, at the position adjacent to the lower below the fixing belt between the heating roller and the nip portion, a recording medium support is arranged to form substantially linear heating path between itself and the fixing belt, and the fixing belt has a thermal capacity of 0.002 cal/° C. to 0.025 cal/° C. per square centimeter of the fixing belt. In this electrophotographic apparatus, low temperature offset and high temperature offset are prevented by defining the thermal capacity of the belt.

Further, in the image-forming apparatus disclosed in JP-B No. 3423616, a spherical toner contains a releasing agent which allows a toner to be released from a fixing member, and a recording medium is heated by means of a heating unit prior to fixation in a heating path so that the melting point of the releasing agent becomes lower than the surface temperature of the recording medium. By using a spherical toner containing the releasing agent having a low melting point, the bleeding-out properties of the releasing agent in a heating path before the nip of a belt fixing apparatus is enhanced to thereby attempt to improve parting ability.

Furthermore, Japanese Patent Application Laid-Open (JP-A) No. 10-63121 discloses an image-fixing apparatus in which a heat source is arranged inside a driving roller of an intermediate transfer member and the intermediate transfer member is brought into pressure contact with a pressure member to form a nip. Toner is heated before reaching the nip and the heated toner is fixed on a recording medium. In this image-fixing apparatus, a secondary transfer from the intermediate transfer member to the recording medium is carried out not by electrostatic force but by heat of fixing. In addition, heating time of toner can be set to a long time.

Moreover, as a toner for use in an image-fixing apparatus according to an electro magnetic induction heating process, the following toner is disclosed. Specifically, JP-A No. 11-344830 discloses a toner in which a resin having a glass transition point of 45° C. to 65° C. and a softening point of 80° C. to 140° C. is used and which contains a ferromagnetic substance for use in the image-fixing apparatus according to an electro magnetic induction heating process.

JP-A No. 2001-235893 discloses a technique where a toner in which a styrene acrylic resin having a defined glass transition point and MI value and a certain polyolefin wax are used, is used in an image-fixing apparatus according to an electro magnetic induction heating process.

JP-A No. 2001-272812 discloses a technique where a toner in which a wax having a defined endothermic peak and in addition, a polyester resin having a defined dynamic viscoelasticity are used, is used in an image-fixing apparatus according to an electro magnetic induction heating process.

Further, JP-A No. 2001-272818 discloses a technique where a toner containing a resin having a defined molecular weight distribution and endothermic peak temperature, is used in an image-fixing apparatus according to an electro magnetic induction heating process.

Furthermore, JP-A No. 2002-91075 discloses a technique where a toner containing a polyester resin having a defined composition of both of an acid and an alcohol, is used in an image-fixing apparatus according to an electro magnetic induction heating process.

And JP-A No. 2002-91076 discloses a technique where a toner which contains a polyester resin having a defined THF insoluble content and acid value and which have a defined melt viscosity, is used in an image-fixing apparatus according to an electro magnetic induction heating process.

However, there is a problem in the techniques disclosed in any one of Patent Literatures that the temperature of any toner rapidly rises up, thus when temperature control is inadequate, an image-fixing apparatus which may become high temperature temporarily has inadequate fixing releasability.

### SUMMARY OF THE INVENTION

Accordingly, an object of the invention is to solve the above-mentioned problems and to provide an image-fixing apparatus and an image-forming apparatus which not only has excellent fixing releasability, but also allows simplification of an image-fixing apparatus, has small size and higher productivity, and maintain high quality.

A first aspect of the invention is an image-fixing apparatus including a fixing belt, a fixing member, a pressure member, and a heating source, wherein the fixing belt is heated by the heating source, wherein the fixing member is brought into pressure contact with the pressure member via the fixing belt to form a nip and a paper carrying an unfixed toner is allowed to pass through the nip, thereby fixing the unfixed toner on the paper, and wherein the toner to be used includes a binder resin, a colorant, and a releasing agent, and wherein the toner has a ½ flown-out temperature of 115° C. to 145° C. and has a storage elastic modulus (G′) at 190° C. of 200 Pa or more.

A second aspect of the invention is an image-fixing apparatus according to the first aspect of the invention, wherein the heating source is one of an induction heating unit and a radiation heating unit.

A third aspect of the invention is an image-fixing apparatus according to the first aspect of the invention, wherein the fixing belt having a low thermal capacity has a thermal capacity of 0.019 J/K per square centimeter of fixing belt to 0.077 J/K per square centimeter of fixing belt.

A fourth aspect of the invention is an image-fixing apparatus according to the first aspect of the invention, wherein the fixing belt comprises a heat generating layer and a release layer, and wherein the heat generating layer of the fixing belt has a thickness of 40 μm or less and the release layer of the fixing belt has a thickness of 10 μm or more.

A fifth aspect of the invention is an image-fixing apparatus according to the first aspect of the invention, wherein the release layer comprises a fluorine resin material.

A sixth aspect of the invention is an image-fixing apparatus according to the first aspect of the invention, wherein the toner comprises, as a resin component, a resin having a THF insoluble content in the resin component of 10% or more.

A seventh aspect of the invention is an image-fixing apparatus according to the first aspect of the invention, wherein the toner has a peak molecular weight of 8,500 to 10,000.

An eighth aspect of the invention is an image-fixing apparatus according to the first aspect of the invention, wherein the toner includes one of a free fatty acid-removed carnauba wax, montan wax, oxidized rice wax, and ester wax, as a releasing agent.

An ninth aspect of the invention is an image-fixing apparatus according to the first aspect of the invention, wherein the fixing member is a fixing roller and the pressure member is a pressure roller, wherein at least one of the fixing roller and the pressure roller has a heat insulating structure, and wherein the pressure roller has rigidity, the hardness of the pressure roller is larger than that of the fixing roller, and the fixing belt rolls by transmission of the driving from the pressure roller.

A tenth aspect of the invention is an image-fixing apparatus including a transfer fixing member; a pressure member; and a heating source, wherein the transfer fixing member carrying an toner image is heated by the heating source, wherein the transfer fixing member is brought into pressure contact with the pressure member to form a nip and a paper is allowed to pass through the nip, thereby fixing a toner on the paper, wherein the toner to be used comprises a binder resin, a colorant, and a releasing agent, and wherein the toner has a ½ flown-out temperature of 115° C. to 145° C. and has a storage elastic modulus (G′) at 190° C. of 200 Pa or more.

An eleventh aspect of the invention is an image-fixing apparatus according to the tenth aspect of the invention, wherein the transfer fixing member includes a transfer fixing belt and a fixing roller, and the transfer fixing belt carrying an toner image is heat by the heating source, the transfer fixing roller is brought into pressure contact with the pressure member via the transfer fixing belt to form a nip and a paper is allowed to pass through the nip, thereby fixing a toner on the paper.

A twelfth aspect of the invention is an image-fixing apparatus according to the eleventh aspect of the invention, wherein the fixing belt includes a heat generating layer and a release layer, and has a low thermal capacity.

A thirteenth aspect of the invention is an image-fixing apparatus according to the tenth aspect of the invention, wherein the transfer fixing member is a transfer fixing roller.

A fourteenth aspect of the invention is an image-fixing apparatus according to the tenth aspect of the invention, wherein the toner comprises, as a resin component, a resin having a THF insoluble content in the resin component of 10% or more.

A fifteenth aspect of the invention is an image-fixing apparatus according to the tenth aspect of the invention, wherein the toner has a peak molecular weight of 8,500 to 10,000.

A sixteenth aspect of the invention is an image-fixing apparatus according to the tenth aspect of the invention, wherein the toner comprises one of a free fatty acid-removed carnauba wax, montan wax, oxidized rice wax, and ester wax, as a releasing agent.

A seventeenth aspect of the invention is an image-forming apparatus including the image-fixing apparatus according to the first aspect of the invention or the image-fixing apparatus according to the tenth aspect of the invention.

The image-fixing apparatus and the image-forming apparatus according to the invention enables not only excellent fixing releasability but also simplification, downsizing and higher productivity of an image-fixing apparatus, and high quality.

### BRIEF DESCRIPTION OF THE DRAWINGS

FIG. 1 is a diagram illustrating an example of the image-fixing apparatus of the invention.

FIG. 2 is a diagram illustrating an example of the image-forming apparatus of the invention.

FIG. 3 is a diagram illustrating another example of the image-fixing apparatus of the invention.

FIG. 4 is a diagram illustrating a modified example of the image-fixing apparatus shown in FIG. 3.

FIG. 5 is a diagram illustrating another modified example of the image-fixing apparatus shown in FIG. 3.

FIG. 6 is a diagram illustrating another modified example of the image-fixing apparatus shown in FIG. 3.

FIG. 7 is a diagram illustrating another example of the image-fixing apparatus of the invention.

FIG. 8 is a diagram illustrating a modified example of the image-fixing apparatus shown in FIG. 7.

FIG. 9 is a diagram illustrating another modified example of the image-fixing apparatus shown in FIG. 7.

FIG. 10 is a diagram illustrating an image-fixing apparatus used in an experiment in the invention.

FIG. 11 is a graph illustrating temperature distribution based on the point of a belt in an experiment.

FIG. 12 is a graph illustrating a temperature range capable of fixing obtained by an experiment.

FIGS. 13A and 13B are graphs which are obtained when ½ flown-out temperature of toner is measured.

### DESCRIPTION OF THE PREFERRED EMBODIMENTS

Best mode for carrying out the invention will be described below. First, a first aspect of the invention will be described. In this aspect, an image-fixing apparatus having the following characteristics is used. Specifically, it comprises a fixing belt, a fixing member, a pressure member, and a heating source, wherein the fixing belt comprises a heat generating layer and a release layer, has a low thermal capacity, and is heated by the heating source, wherein the fixing member is brought into pressure contact with the pressure member via the fixing belt to form a nip and a paper carrying an unfixed toner is allowed to pass through the nip, thereby fixing the unfixed toner on the paper, wherein a toner to be used comprises a binder resin, a colorant, and a releasing agent, and wherein the toner has a ½ flown-out temperature of 115° C. to 145° C. and has a storage elastic modulus (G′) at 190° C. of 200 Pa or more. In addition, a toner in which a resin having a THF insoluble content of 10% or more in the resin component of the toner is used and, of a free fatty acid-removed carnauba wax, montan wax, oxidized rice wax, and ester wax, any one wax thereof is used as a releasing agent, is preferably used. Here, in this aspect, the pressure roller is used as the pressure member, but in addition to the pressure roller, belt type member can be used as the pressure member (hereinafter the same).

Namely, a problem specific to a heating belt is that increase of belt rigidity causes expansion at nip exit and invite reduced peelability or releasability between a belt surface and a toner. In particular, a belt for induction heating comprises conductive, metallic heat generating member, which leads to larger belt rigidity than the belts used in other belt fixing methods and as a result, expansion becomes larger, curvature of the nip exit is small and parting ability decreases. Consequently, releasability between a toner and the surface of a fixing member is reduced.

Namely, compared to a conventional belt for radiation heat source (e.g. halogen lamp), heat belt has larger rigid for requirement of a heat generating layer (metallic conductive material). Thus, nip width is reduced, causing reduced fixing quality (image-fixing properties, gloss, and higher image quality).

In the invention, in order to cope with this problem, larger fixing pressure is provided to the belt having a large rigid and large surface hardness to ensure a predetermined nip wide upon belt fixing by means of induction heating. Namely, increase of the surface pressure makes fixing quality (image-fixing properties, gloss, and higher image quality) satisfactory and at the same time, improves release properties.

Further, the fixing belt used in the invention has belt self-cooling effect. Heat is applied to the fixing belt outside a nip region, and thereby the fixing belt store heat therein. When a paper having an unfixed toner passes through the nip, the fixing belt supplies the toner and the paper with heat, thereby allowing the toner to be fixed. On the other hand, the fixing belt itself is cooled off by a corresponding amount, and the temperature of which is lowered. In this state, the once fused toner take a turn for recovery of elasticity, release properties between the toner and the fixing belt are improved and hot offset can be prevented.

In this case, the small and large of self-cooling effect depends on the small and large of a thermal capacity of a belt. Specifically, if the thermal capacity of the belt is small, self-cooling effect is large, resulting in the increase of the temperature at which hot offset generates. In contrast, if the thermal capacity of the belt is too small, heat supply runs short, which causes fixing failure. In order to confirm the self-cooling effect, the following 9 kinds of fixing belt, a to i were selected to examine.

Relationship between a configuration of induction heating belt:

substrate (Ni, PI)
+heat generating layer (Ni, Ag, SUS, etc. as a conductive material)
+interlayer (serving as an elastic layer and intended for uniform fixing)
+surface layer (=release layer, which is made of a fluorine resin material and intended for release effect and oilless), and thermal capacity;
a. PI (25 μm)+Ni (10 μm)+fluorine resin (10 μm)=0.01 J/K per square centimeter of fixing belt (Hereinafter “J/K per square centimeter of: fixing belt” may be abbreviated as “J/k cm²”.)
b. Ni (40 μm)+fluorine resin (20 μm)=0.019 J/k cm²
c. Ni (40 μm)+Si rubber (150 μm)=0.038 J/k cm²
d. Ni (40 μm)+Si rubber (150 μm)+fluorine resin (30 μm)=0.045 J/k cm²
e. PI (50 μm)+Ni (40 μm)+Si rubber (150 μm)+fluorine resin (20 μm)=0.052 J/k cm²
f. PI (50 μm)+Ni (40 μm)+Si rubber (200 μm)+fluorine resin (20 μm)=0.068 J/k cm²
g. PI (75 μm)+Ni (40 μm)+Si rubber (200 μm)+fluorine resin (20 μm)=0.072 J/k cm²
h. PI (100 μm)+Ni (40 μm)+Si rubber (200 μm)+fluorine resin (20 μm)=0.077 J/k cm²
i. PI (100 μm)+Ni (40 μm)+Si rubber (300 μm)+fluorine resin (30 μm)=0.087 J/k cm²
   Experimental Conditions;
Fixing belt; thermal capacity of the belt of the a to h
Fixing roller; φ 38 (Si form, layer thickness 5 mm)
Pressure roller; φ 40 (cored bar of iron 1.0 mm+Si rubber 0.5 mm+PFA 30 μm)
Heating roller; φ 30 (aluminum, 0.8 mm)
Fixing condition; nip time (100 ms)
Toner; Toner 1, 2, or 3 of the invention mentioned later

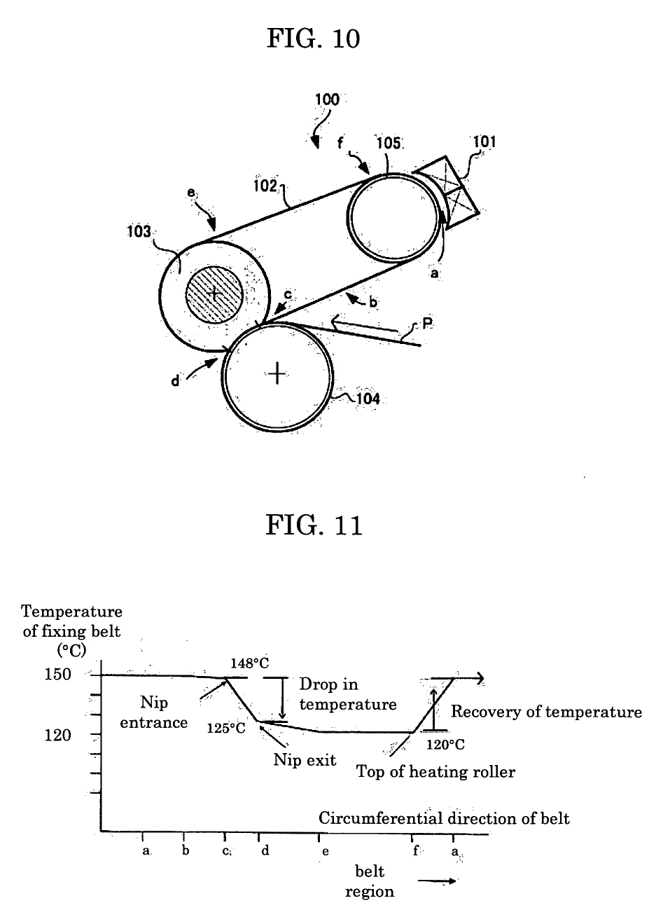

The belt having low thermal capacity in which heat is stored in advance supplies heat with papers and toners passing a nip, thus, the temperature of the belt decreases dramatically when moving from an entrance of a nip to an exist of the nip. By this self-cooling effect, at the exit of the nip, the temperature of the belt and toner interface contacting therewith is sufficiently low compared with that according to a conventional heat roller process. As an experimental example of the invention, this was confirmed using the experimental apparatus shown in FIG. 10 under the above-mentioned experimental conditions. In FIG. 10, the reference character 100 is an image-fixing apparatus as an experimental apparatus which comprises an induction heating source 101, fixing belt 102, fixing roller 103, pressure roller 104 and inverting roller 105. Further, temperature was measured at the point a or f in the figure. This result is shown in FIG. 11.

As shown in FIG. 11, it is found that at the fixing belt 102 of the present example, the temperature of the fixing belt 102 decreases by 20° C. to 30° C. in the region of self-cooling effect of a belt. Specifically, it was found that the fused toner by receiving heat supply in a nip changed its state towards recovery of elastic due to the above-mentioned temperature-lowering effect to be in a state where hot offset is hard to occur.

Namely, it was that when a toner was cooled, the state of the toner changed towards such a state that the viscoelasticity of the toner advantageously affects the releasability between the toner and the belt, demonstrating releasing effect.

The fixing belt 102 according this aspect is a belt having low thermal capacity which comprises a heat generating layer and a release layer, and the heat generating layer preferably has a thickness of 40 μm or less and the release layer preferably has a thickness of 10 μm or more. If the thickness of the heat generating layer (metallic conductive materials, e.g. Ni, SUS) exceeds 40 μm, belt rigidity increases, belt-specific bendability become impaired, twining capability of a belt around a fixing roller and nip formability deteriorates, and parting ability and image-fixing properties are reduced. Further, the surface release layer is required to have a thickness of at least 10 μm in order to ensure anti abrasion properties with time.

Moreover, in order to improve release properties, and in addition, to make oilless fixation possible, the release material of the surface of the fixing belt 102 is preferably fluorine resins. Note that if oil is applied, Si rubber is preferred.

As an experimental example of this aspect, an experiment for confirmation was conducted using the image-fixing apparatus 100 under the above-mentioned experimental conditions. Results are shown in Table 1.

TABLE 1

| | | Thermal capacity | | Image-fixing |
|---|---|---|---|---|
| | Configuration of fixing belt | of belt | Hot off-set | properties |
| a | PI (25 μm) + Ni (10 μm) + fluorine resin (10 μm) | 0.01 J/k cm² | Good | Poor |
| b | Ni (40 μm) + fluorine resin (20 μm) | 0.019 J/k cm² | Good | Fair |
| c | Ni (40 μm) + Si rubber (150 μm) | 0.038 J/k cm² | Good | Good |
| d | Ni (40 μm) + Si rubber (150 μm) + fluorine resin (30 μm) | 0.045 J/k cm² | Good | Good |
| e | PI (50 μm) + Ni (40 μm) + Si rubber (150 μm) + fluorine resin (20 μm) | 0.052 J/k cm² | Good | Good |
| f | PI (50 μm) + Ni (40 μm) + Si rubber (200 μm) + fluorine resin (20 μm) | 0.068 J/k cm² | Good | Good |
| g | PI (75 μm) + Ni (40 μm) + Si rubber (200 μm) + fluorine resin (20 μm) | 0.072 J/k cm² | Good | Good |
| h | PI (100 μm) + Ni (40 μm) + Si rubber (200 μm) + fluorine resin (20 μm) | 0.077 J/k cm² | Fair | Good |
| i | PI (100 μm) + Ni (40 μm) + Si rubber (300 μm) + fluorine resin (30 μm) | 0.087 J/k cm² | Poor | Good |

Table 1 indicates that in the combinations of the toner according to the invention and thermal capacity of the belt, if the thermal capacity is 0.019 J/kcm² or less, there is no problem in hot offset properties, but drop of the temperature in a nip is large and image-fixing properties deteriorates. In order to solve such problem, means to prevent the problem by increasing fixing temperature can be adopted, but energy saving effect (high-speed start-up) cannot be obtained. In contrast, if the thermal capacity is 0.077 J/kcm² or more, conversely, the self-cooling effect is small, thus inviting the generation of hot offset. On the other hand, the image-fixing properties are improved.

Namely, it was found that in order to satisfy the image-fixing properties and the hot offset properties at the same time, the thermal capacity of the fixing belt is preferably in the range of 0.019 J/kcm² to 0.077 J/kcm²

Moreover, by widening a nip sufficiently, low-temperature fixing is allowed, further by promoting to insulate one of the fixing roller which forms a nip via the belt having low thermal capacity and the pressure roller, or both of them (make either of them or both a elastic foam or rigid form), image-fixing properties and release properties are improved. Namely, image-fixing efficiency by stored heat energy of the heating belt is improved.

Specifically, by selecting an insulated roller having rigidity (herein defined as one having Asker C hardness of 80 degrees or more) as a pressure roller and by setting such that the hardness of a pressure roller is larger than that of a fixing roller, a belt can be stability conveyed. At the same time, a fixing nip is formed in the direction where a paper does not wind around the belt, and therefore, parting ability is improved. As a result, releasability between the toner and the surface of the fixing member is improved. As a heat insulating structure, examples include a silicon rubber form; or a hollow fiber, hollow particles, etc. are arranged inside a silicon layer, thereby increasing air content and achieving increased insulating effect by air.

Further, the roller having such structure (structure in which hollow fiber, hollow particles, etc. are arranged inside a silicon layer) has a large surface hardness and a small compression set, and thus can be used as a belt driving roller. Furthermore, the fixing member may be composed of an elastic foam (Si rubber). In addition, the pressure roller may be a roller having thin thickness and low thermal capacity (cored bar thickness of 1 mm or less).

The differences of induction heating and radiation heat source (halogen lamp) will be described here. An induction heating process generally has the following features, compared to a radiation heating (halogen lamp) process:
high energy conversion efficiency (up to 85%, fast set up time, that of halogen lamp is about 10% lower.
Frequency variability allows output variability (difficult in case of halogen lamp)
Self temperature control is allowed utilizing magnetic properties (Curie point) of the objects to be heated and in addition, advantageous in terms of safety (e.g., burnout, ignition).
temperature ripple is small (have merits such as small time lag against temperature control, etc. since the objects to be heated is directly heated),
high safety (no risk of ignition).

It was revealed that in the image-fixing apparatus of the invention, the rate of increasing temperature until temperature reaches required fixing temperature is extraordinary fast, on the other hand, in some cases, temperature temporarily becomes excessively high, when a conventional toner is used, offset occurs easily and therefore, a toner causing no occurrence of offset are required.

Next, a toner for use in the invention will be described below. Many characteristics of the toner related to toner-fixing properties have been known; however, regarding to those of the image-fixing apparatus of the invention, particularly release properties, it was revealed that satisfactory release properties can be obtained only by satisfying the condition that ½ flown-out temperature and storage elastic modulus at 190° C., respectively, is in a specific range.

Specifically, when the ½ flown-out temperature is lower than 115° C., in some cases, hot offset occurs, conversely, when the ½ flown-out temperature is higher than 145° C., there are some cases where adequate toner-fixing properties cannot be obtained and image is easily peeled off transfer paper.

Further, when the storage elastic modulus at 190° C. is smaller than 200 Pa, hot offset may occur at the time of fixation.

Furthermore, in particular, the THF insoluble content in the resin composition of a toner is preferably 10% or more. This allows an object of the invention to be achieved more certainly. In other words, when the THF insoluble is smaller than 10%, hot offset may occur at the time of fixation.

Further, the molecular weight of the toner is preferably in the range of 8,500 to 10,000. It was confirmed that this prevented offset at the time of fixation, and at the same time, image-fixing properties were satisfactory. If the molecular weight of the toner is less than 8,500, hot offset may occur, and if it is more than 10,000, image-fixing properties may be inadequate.

Furthermore, as a releasing agent, of a free fatty acid-removed carnauba wax, montan wax, oxidized rice wax, ester wax, any one of waxes is preferably used. This enables the prevention of the offset at the time of fixation of toner certainly. These waxes have a variety of characteristics suitable as a releasing agent of a toner which is used in the image-fixing apparatus of the invention.

As the carnauba wax, ones in the form of microcrystal is suitable, and among these, ones having an acid value of 5 or less and having particle diameter of 1 μm or less when dispersed in a toner binder are preferable. The montan wax refers to montan-based wax generally refined from minerals. Like the carnauba wax, the montan wax is preferably microcrystal and has an acid value of 5 to 14. In the case where the acid value is less than the above-mentioned rage, low-temperature fixing temperature increases, resulting in poor low-temperature fixation. Conversely, in the case where the acid value exceeds respective range, cold offset temperature increases, resulting in poor low-temperature fixation. The oxidized rice wax is rice bran wax oxidized with air, the acid value thereof is preferably 10 to 30. The advantage of the acid value is alike. The ester wax is synthetically-prepared one, and a variety of them can be used. The additive amount of these releasing agents is 2 parts by weight to 20 parts by weight, preferably 3 parts by weight to 15 parts by weight, more preferably 4 parts by weight to 12 parts by weight relative to 100 parts by weight of resin in a toner.

When the additive amount of the releasing agent is less than the above-mentioned range, satisfactory fixing releasability are not achieved and hot off-set may occur. Conversely, when it exceeds the range, the releasing agent may detach from the surface of the toner, adhere to a carrier, or members, a photoconductor, etc in a developing unit, thereby original functions thereof may be damaged.

½ flown-out temperature, storage elastic modulus (G′), peak molecular weight of the toner will be described below.

½ Flown-Out Temperature

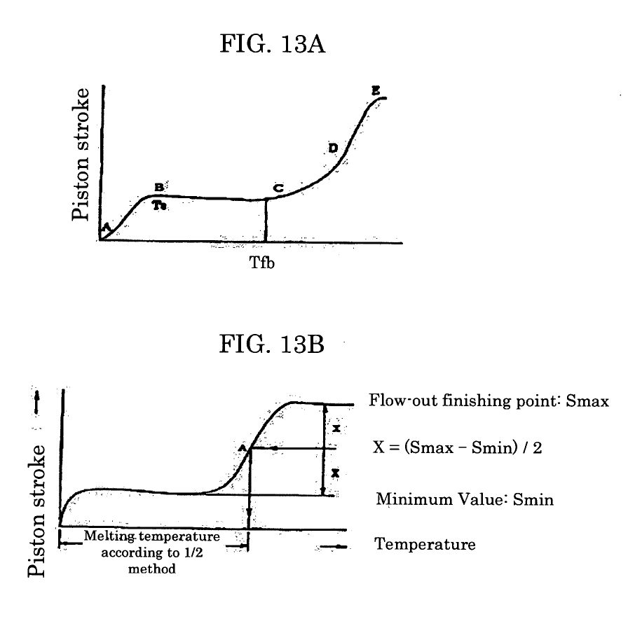

Flow-out beginning temperature can be measured using a flow tester. Examples of the flow tester include a capillary type flow tester CFT500D (available from Shimadzu Corporation). FIGS. 13A and 13B shows a flow curve of this flow tester, and from this graph, each temperature can be read. In the figure, Tfb represents flow-out beginning temperature and melting temperature according to ½ method represents T_{1/2} temperature.

Measurement was carried out under the following conditions:
Load: 5 kg/cm², Temperature rising rate: 3.0° C./min, Die diameter: 1.00 mm, Die length: 10.0 mm
   Storage Elastic Modulus (G′)

2 gram of sample is fixed on a parallel plate using RheoStress RS50 (avail from HAAKE) and storage elastic modulus (G′) was measured under the following conditions:
Frequency: 1 Hz, Temperature: 80° C. to 210° C., Strain 0.1, Rate of temperature rise: 3° C./Min.
Storage elastic modulus (G′) at 190° C. is read out.
   Peak Molecular Weight

The peak molecular weight of the toner component is measured according to the following method. After about 1 gram of toner is precisely measured, 10 gram to 20 gram of tetrahydrofuran (THF) is added to prepare THF solution with a binder concentration of 5% to 10%. A column is stabilized in a heat chamber heated at 40° C. Into the column at this temperature, 20 μl of the THF sample solution was injected, running THF as a solvent at a flow rate of 1 ml/min. Molecular weight of the sample is calculated from the relationship between the logarithmic value of calibration curve obtained from monodisperse polystyrene standard samples and the retention time. The calibration curve is obtained using polystyrene standard samples. Examples of the monodisperse polystyrene standard samples for use include ones having molecular weight ranging from 2.7×10² to 6.2×10⁶ commercially available from Tosoh Corporation. For the detection, a refractive index (R1) detector can be used. Examples of the Column for use include combinations of TSKgel, G1000H, G2000H, G2500H, G3000H, G4000H, G5000H, G6000H, G7000H, and GMH.

Further, as a binder resin used in the toner of the invention, those having the following compositions can be used as long as they satisfy properties of toner of the invention.

Examples thereof include homopolymers of styrene or substituted styrene such as polyester, polystyrene, poly-p-chlorostyrene, and polyvinyltoluene; and styrene-based copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-alpha-chloromethacrylate copolymer, styrene-acrylonitrile copolymer, styrene-vinylmethyl ether copolymer, styrene-vinylethyl ether copolymer, styrene-vinylmethyl ketone copolymer, styrene-butadiene copolymer, styrene-isoprene copolymer, styrene-acrylonitrile-indene copolymer, styrene-maleic acid copolymer, and styrene-maleic acid ester copolymer.

Further, the following resins can be used by mixture. Examples include polymethylmethacrylate, polybutylmethacrylate, polyvinyl chloride, polyvinyl acetate, polyethylene, polypropylene, polyurethanes, polyamides, epoxy resins, polyvinylbutylal, polyacrylic resins, rosin, modified rosin, terpene resins, phenol resin, aliphatic or alicyclic hydrocarbon resins, aromatic petroleum resins, chlorinated paraffin, paraffin wax, and the like.

Among these, polyester resin is particularly preferred in order to obtain satisfactory image-fixing properties. The polyester resin can be obtained by condensation polymerization of alcohol and carboxylic acid, and examples of the alcohol for use include diols such as polyethyleneglycol, diethyleneglycol, triethyleneglycol, 1,2-propylene glycol, 1,3-propylene glycol, 1,4-butane diol, neopentyl glycol, 1,4-butene diol; etherified bisphenols such as 1,4-bis(hydroxyl-methyl) cyclohexane, bis-phenol A, hydrogenated bisphenol A, polyoxy-ethylenated bisphenol A, polyoxy-propylenated bisphenol A, divalent alcohols in which these are substituted with saturated or unsaturated hydrocarbon groups having a carbon number of 3 to 22, and other divalent alcohols.

Examples of the carboxylic acid for use in order to obtain the polyester resin include maleic acid, fumaric acid, mesaconic acid, citraconic acid, itaconic acid, glutaconic acid, phthalic acid, isophthalic acid, terephthalic acid, cyclohexanedicarboxylic acid, succinic acid, adipic acid, sebacic acid, malonic acid, divalent organic acid monomers in which these are substituted with saturated or unsaturated hydrocarbon groups having a carbon number of 3 to 22, and acid anhydride thereof, dimmer of lower alkylester and linolenic acid; and other divalent organic acid monomers.

In order to obtain the polyester resin used as a binder resin, not only polymers composed of the above-mentioned difunctional monomers, but also polymers containing components of polyfunctional monomers having three or more functionalities are suitably used. Examples of a polyhydric alcohol monomer three or more functionalities, which is such polyfunctional monomer, include sorbitol, 1,2,3,6-hexanetetrol, 1,4-sorbitan, pentaerythritol, di-pentaerythritol, tripentaerythritol, sucrose, 1,2,4-butanetriol, 1,2,5-pentanetriol, glycerol, 2-methylpropanetriol, 2-methyl-1,2,4-butanetriol, trimethylol ethane, trimethylol propane, 1,3,5-trihydroxymethyl benzene, and the like

Examples of tricarboxylic or more polycarboxylic acid monomer include 1,2,4-benzenetricarboxylic acid, 1,2,5-benzene tricarboxylic acid, 1,2,4-cyclohexanetricarboxylic acid, 2,5,7-naphthalenetricarboxylic acid, 1,2,4-naphthalenetricaboxylic acid, 1,2,4-butanetricaboxylic acid, 1,2,5-haxanetricaboxylic acid, 1,3-dicarboxyl-2-methyl-2-methylenecarboxylic-propane, tetra(methylenecalboxylic)methane, 1,2,7,8-octane tetracarboxylic acid, empol trimer acid, and acid anhydride thereof, and the like.

Further, the toner of the invention may comprise a releasing agent in order to improve release properties of the toner on the surface of the fixing belt at the time of fixation of toner. As a releasing agent, any known releasing agents can be used, and particularly, a free fatty acid-removed carnauba wax, montan wax, oxidized rice wax, and ester wax can be used alone or in combination. As the carnauba wax, ones in the form of microcrystal is suitable, and among these, ones having an acid value of 5 or less and having particle diameter of 1 μm or less when dispersed in a toner binder are preferable. The montan wax generally refers to montan-based wax refined from minerals. Like the carnauba wax, the montan wax is preferably microcrystal and has an acid value of 5 to 14. The oxidized rice wax is rice bran wax oxidized with air, the acid value thereof is preferably 10 to 30. In the case where the acid value of each wax is less than the respective range, low-temperature fixing temperature increases, resulting in poor low-temperature fixation. Conversely, in the case where the acid value exceeds each range, cold offset temperature increases, resulting in poor low-temperature fixation. The additive amount of the wax is 1 parts by weight to 15 parts by weight, preferably 3 parts by weight to 10 parts by weight, relative to 100 parts by weight of binder resin. When the additive amount of the wax is less than 1 part by weight, the releasing capability is hardly exhibited and a desired effect cannot be achieved. When it exceeds 15 parts by weight, problems may occur such as a consumption of the toner to carrier becoming excessive.

Further, in order to provide a toner with charge, a charge controlling agent may be contained. As the charge controlling agent, any conventionally known charge controlling agent may be used. Examples of positive charge controlling agent include nigrosine, basic dyes, lake pigments of basic dyes, quaternary ammonium salts, and the like. Examples of a negative charge controlling agent include metal salts of mono azo dyes; metal complexes of salicylic acid, naphthoic acid and dicarboxylic acids; and the like. The amount of the polarity controlling agent to be used is decided depending on the types of the binder resin, presence or absence of an additive agent which is used according to necessity, and a method for producing a toner including dispersion method, thus is not limited unconditionally, but ranges 0.01 parts by weight to 8 parts by weight, preferably 0.1 parts by weight to 2 parts by weight relative to 100 parts by weight of the binder resin. If the amount of the polarity controlling agent is less than 0.01 parts by weight, sufficient charge controlling abilities hardly exhibit relative to fluctuations of the charge amount QIM under environmental fluctuations. If it exceeds 8 parts by weight, low temperature image-fixing properties may decline.

Further, as a metal-containing mono azo dye to be used, a chromium-containing mono azo dye, a cobalt-containing mono azo dye, an iron-containing mono azo dye can be used alone or in combination. Addition of these makes the start up (time to saturation) of the charge amount Q/M in a developer superior. The amount of the metal-containing mono azo dye to be used is decided, like the polarity controlling agent, depending on the types of the binder resin, presence or absence of an additive agent which is used according to necessity, and a method for producing a toner including dispersion method, thus is not limited unconditionally, but ranges 0.1 parts by weight to 10 parts by weight, preferably 1 parts by weight to 7 parts by weight relative to 100 parts by weight of the binder resin. If the amount of the metal-containing mono azo dye is less than 0.1 parts by weight, sufficient effect cannot be obtained. If it exceeds 10 parts by weight, defects such as a reduced saturation level of the charge amount occur.

Further, metal salts of a salicylic acid derivative is particularly preferably used for a color toner, but according to necessity, addition of a transparent or white substance which does not impair color tone of the color toner can provide a toner with charge stably. Specifically, organic boron salts, fluorine containing quaternary ammonium salts, calixarene compounds, or the like are used, but the transparent or white substance is not limited thereto.

Further, the toner of the invention can be used as a magnetic toner by further containing magnetic materials. Examples of the magnetic materials contained in the magnetic toner of the invention include iron oxides such as magnetite, hematite, and ferrite; metals such as iron, cobalt, and nickel; or alloys of these metals with metals such as aluminium, cobalt, copper, lead, magnesium, tin, zinc, antimony, beryllium, bismuth, cadmium, calcium, manganese, selenium, titanium, tungsten or vanadium; and mixtures of the above-mentioned materials.

Of these ferromagnetic materials, ferromagnetic materials having an average particle diameter of about 0.1 μm to 2 μm are desirable, the content of the ferromagnetic material is about 20 parts by weight to 200 parts by weight relative to 100 parts by weight of resin component, particularly preferably 40 parts by weight to 150 parts by weight relative to 100 parts by weight of resin component.

As a colorant, any known colorants for toner can be used. As a black colorant, for example, carbon black, aniline black, furnace black, lamp black, and the like can be used. As a cyan colorant, for example, Phthalocyanine Blue, methylene blue, Victoria blue, methyl violet, Aniline Blue, ultramarine blue, and the like can be used. As a magenta colorant, for example, Rhodamine 6G Lake, dimethylquinacridone, Watching red, Rose Bengale, Rhodamine B, alizarin lake, and the like can be used. As a yellow colorant, for example, chrome yellow, Benzidine Yellow, Hanza yellow, naphthol yellow, molybdate orange, quinoline yellow, tartrazine, and the like can be used. The colorant used in the toner of the invention may be any pigment or dye which allows a yellow, magenta, cyan or black toner to be obtained. Any conventionally known pigment or dye can be used alone or in combination. Examples of thereof include carbon black, lamp black, ultramarine blue, Aniline Blue, Phthalocyanine Blue, Phthalocyanine Green, Hanza yellow G, Rhodamine 6G, lake, chalco oil blue, chrome yellow, quinacridon, Benzidine Yellow, Rose Bengale, triarylmethane-based dye, and the like. Further, in order to improve flowability of the toner, hydrophobic silica, titanium oxide, alumina, or the like may be added as an external additive, and fatty acid metal salts, polyvinylidene fluoride, or the like may further be added according to necessity.

Further, when the toner of the invention is used as a two-component developer, any known carrier can be used. Example thereof includes fine particles having magnetism such as iron powder, ferrite powder, and nickel powder; glass beads, etc. and ones obtained by treating the surface thereof with rein or the like; and the like.

Resin powder with which the carrier according to the invention can be coated includes styrene-acrylic copolymer, silicone resin, maleic acid resin, fluorine resin, polyester resin, epoxy resin, and the like. The styrene-acrylic copolymer preferably has a styrene component of 30% by weight to 90% by weight. In this case, styrene-acrylic copolymer having a styrene component less than 30% by weight causes poor developing properties. If it exceeds 90% by weight, coating film becomes hard, inviting film peeling and resulting in short lifetime. Further, resin coating of the carrier in the invention may comprise tackifier, curing agent, lubricant agent, conductive material, charge controlling agent, and the like other than the above-mentioned resin.

In the invention, carrier core particles coated with the silicone resin may be conventionally known ones. Examples thereof include ferromagnetic metal such as iron, cobalt, and nickel; alloys or compounds such as magnetite, hematite, and ferrite; glass beads; and the like. The average particle diameter of these core particles is normally 10 μm to 1,000 μm, and preferably 30 μm to 500 μm. Note that the amount of the silicone resin to be used is normally 1% by weight to 10% by weight relative to the carrier core particles.

Further, the silicone resin for use in the invention may be any conventionally known silicone resins, commercially available examples are such as KR261, KR271, KR272, KR275, KR280, KR282, KR285, KR251, KR155, KR220, KR201, KR204, KR205, KR206, SA-4, ES1001, ES1001N, ES1002T and KR3093 manufactured by Shin-Etsu Silicones, and SR2100, SR2101, SR2107, SR2110, SR2108, SR2109, SR2115, SR2400, SR2410, SR2411, SH805, SH806A and SH840 manufactured by Toray Silicone Co., Ltd. As a method for forming a layer of silicone resin, likewise conventional methods, such a method is employed as that the silicone resin is applied to the surface of the carrier core particle by means of a spraying method, dipping method, or the like.

A second aspect of the invention is an image-fixing apparatus comprising a transfer fixing member; a pressure member; and a heating source, wherein the transfer fixing member carrying an toner image is heated by the heating source, wherein the transfer fixing member is brought into pressure contact with the pressure member to form a nip and a paper is allowed to pass through the nip, thereby fixing a toner on the paper, wherein the toner to be used comprises a binder resin, a colorant, and a releasing agent, and wherein the toner has a ½ flown-out temperature of 115° C. to 145° C. and has a storage elastic modulus (G′) at 190° C. of 200 Pa or more.

Various kinds of aspects of the image-fixing apparatus according to the invention will be described in more detail below with reference to the drawings, which are not intended to limit the invention thereto.

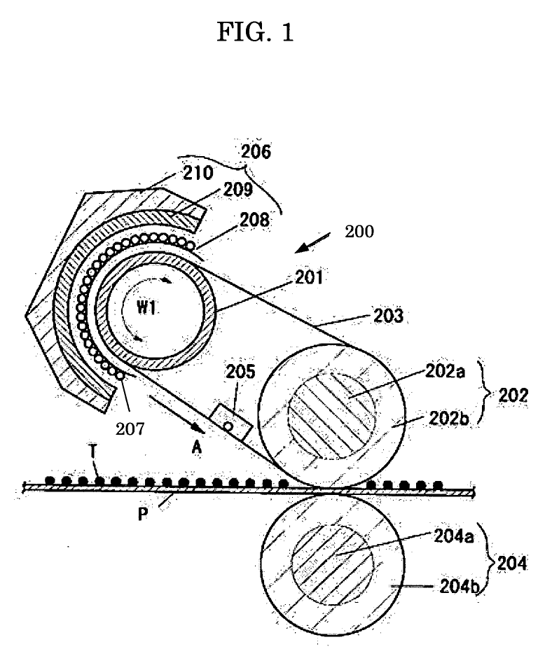

FIG. 1 shows an image-fixing apparatus 200 according to an electro magnetic induction heating process, which is one example of aspects of the invention. The image-fixing apparatus 200 shown in FIG. 1 comprises a heating roller 201, fixing roller 202, fixing belt 203, and pressure roller 204. The heating roller 201 is heated by electromagnetic induction of an induction heating unit 206. The fixing roller 202 is arranged parallel to the heating roller 201. The endless fixing belt 203 is spanned over the heating roller 201, fixing roller 202 and is heated by the heating roller 201, and rolls in the arrow A direction by the rolling of one of these roller. The pressure roller 204 is brought into pressure contact with the fixing roller 202 via the fixing belt 203, and rolls in the forward direction towards the fixing belt 203.

The heating roller 201 comprises hollow circular cylindrical magnetic metal member made of, for example, iron, cobalt, nickel, or alloys of these metals, and the outside diameter of the heating roller may be set to, for example, 20 mm to 40 mm and the thickness thereof may be set to, for example, 0.3 mm to 1.0 mm. This configuration enables low heat capacity and fast temperature rising.

The fixing roller 202 comprises a cored bar 202a made of metal such as stainless-steel and an elastic member 202b which is made of silicon rubber having heat resistance in solid form or in foam form and coats the cored bar 202a. In order to form contact parts with a predetermined width between the pressure roller 204 and the fixing roller 202 by a pressing force from the pressure roller 204, the outside diameter of the is set to about 20 mm to 40 mm, which is larger than that of the heating roller 201. Elastic member 202b has a thickness of about 4 mm to about 6 mm, and has a hardness of about 10° to about 50° (Asker C hardness). This configuration makes the heat capacity of the heating roller 201 to be smaller than that of the fixing roller 202, and thus the heating roller 20 is rapidly heated and warm up time is shortened.

The belt 203 which is spanned over the heating roller 201 and the fixing roller 202, is heated at a contact site W1 between itself and the heating roller 201 which is heated by the induction heating unit 206. Then, by rolling of rollers 201 and 202, inside of the belt 203 is consecutively heated and as a result, the entire belt is heated.

It is desirable that the release layer of the belt 203 have a thickness of about 10 μm to about 300 μm, and particularly about 200 μm. This enables uniform heat fusion of toner image T since the surface layer portion of the belt 203 fully wraps the toner image T formed on a recording medium P. Further, the release layer, i.e., surface release layer, is required to have a thickness of at least 10 μm to ensure anti abrasion properties with time.

Further, when the release layer has a thickness more than 300 μm, the heat capacity of the belt 203 becomes large, resulting in longer time to warm up. In addition, in a toner fixing step, the surface temperature of the belt is hard to decrease and aggregating effect of fused toner at the exit of fixing part cannot be obtained, generating so-called hot off-set, i.e., adhesion of a toner to a belt due to decrease of release properties of the belt.

Note that as the base material of the belt 203, instead of a heat generating layer 203 made of the above-mentioned metal, resin layer having heat resistance such as fluorine resin, polyimide resins, polyamide resins, polyamide-imide resins, PEEK resins, PES resins, and PPS resins, may be used.

The pressure roller 204 comprises a cored bar 204a which is a circular member made of metal having good heat conductance such as, for example, copper or aluminum; and an elastic member 204b which is arranged on the surface of this cored bar 204a and has high heat resistance and toner releasing properties. Besides the above-mentioned metals, SUS may be used in the cored bar 204a.

The pressure roller 204 presses the fixing roller 202 via the belt 203 to form a fixing nip portion N. In this aspect, the pressure roller 204 has higher hardness than the fixing roller 202, and thus the pressure roller 204 makes inroads into the fixing roller 202, which causes the recording material P to be arranged along the circumferential shape of the surface of the pressure roller 204. In this way, the effect that the separation of the recording material P from the belt 203 is facilitated is achieved. This pressure roller 204 has an outside diameter of about 20 mm to about 40 mm as in the fixing roller 202, but the wall thickness thereof is about 0.5 mm to about 2.0 mm, which is thinner than that of the fixing roller 202. Further, the pressure roller 204 has a hardness of about 80° to about 100° (Asker C hardness), and therefore, as mentioned-above, is configured to be harder than the fixing roller 202.

The induction heating unit 206 which heats the heat roller 201 by means of electromagnetic induction comprises, as shown in FIG. 1, an exciting coil 207 as a magnetic field generating unit, and a coil guide plate 208 around which the exciting coil 207 is winded. The coil guide plate 208 is closely arranged to the outer circumferential surface of the heat roller 201 and is in a half cylinder shape. A long piece of wire rod for an exciting coil is alternately winded along the coil guide plate 208 in the axial direction of the heat roller 201 to form the exciting coil 207. Note that the oscillation circuit of the exciting coil 207 is connected to a frequency-variable driving power source (not shown). Outside the exciting coil 207, an exciting coil core 209 which is formed of a ferromagnetic material such as ferrite and is in a half cylinder shape is fixed to an exciting coil core supporting member 210 and closely arranged to the exciting coil 207.

Note that an exciting coil core 209 for use in this aspect has a relative magnetic permeability of 2,500. A high-frequency alternating current of 10 kHz to 1 MHz, and preferably 20 kHz to 800 kHz is supplied from the driving power source to the exciting coil 207, thereby an alternating magnetic field is generated. The alternating magnetic field works on the heat roller 201 and the heat generating layer 203a of the belt 203 in the contact region W1 of the heat roller 201 and the fixing belt 203 and in the vicinity thereof. Inside them, eddy currents I flow in the direction preventing change of the alternating magnetic field.

The eddy currents I cause to generate the Joule heat depending on the resistance of the heat roller 201 and the heat generation layer 203a, i.e., mainly in the contact region of the heat roller 201 and the belt 203 and in the vicinity thereof, the belt 203 comprising the heat roller 201 and the heat generating layer 203a is heated by means of electromagnetic induction.

The inner surface temperature of the thus-heated belt 203 is detected by means of temperature detecting means 205 which is arranged in contact with the inner surface of the belt 203 in the vicinity of the entrance of the fixing nip portion N and comprises temperature-sensitive element having high thermal responsiveness such as a thermistor.

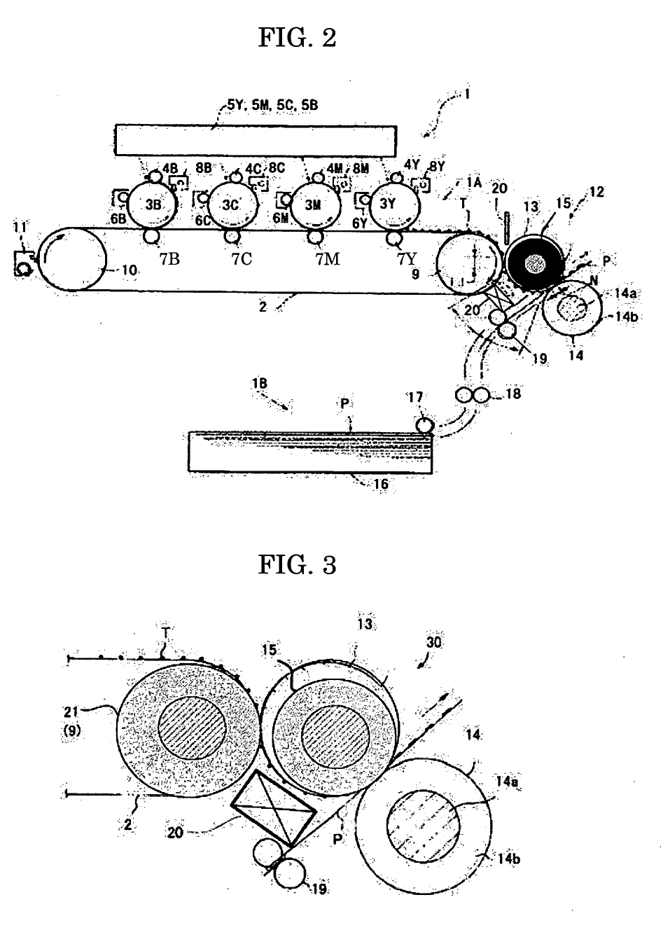

FIG. 2 shows a tandem-type color copier, which is one example of the image-forming apparatus in which the image-fixing apparatus of the invention. This color copier 1 comprises an image forming section 1A positioned at the center of the main body thereof a paper feeding section 1B positioned below the image forming section 1A, and an image scanning section (not shown) positioned above the image forming section 1A.

In the image forming section 1A, an intermediate transfer belt 2 having a transfer surface extending in the horizontal direction as an intermediate transfer member, is arranged. On the upper surface of the intermediate transfer belt 2, arrangements for forming an image with colors which are complementary colors of the colors separated by color separation, are made. Specifically, photoconductors 3Y, 3M, 3C, and 3B, each of which serves as an image carrier capable of bearing a toner image with color (yellow, magenta, cyan, or black) which is complementary color, are parallel arranged along the transfer surface of the intermediate transfer belt 2.

Each of the photoconductors 3Y, 3M, 3C, and 3B is composed of a drum capable of rolling in the same direction (in anticlockwise direction). Around them, a charging unit 4 which carries out image-forming processing during a rolling process, a writing unit 5 as an optical writing unit, an image developing unit 6, a primary transfer unit 7, and a cleaning unit 8 are arranged. The alphabet attached to each reference character corresponds to individual toner colors, as in the photoconductor 3. Each image developing unit 6 houses corresponding color toner.

The intermediate transfer belt 2 is spanned over a driving roller 9, and a driven roller 10, faces photoconductors 3Y, 3M, 3C, and 3B, and is configured to be capable of moving in the same direction. At the position facing the driven roller 10, a cleaning unit 11 for cleaning the surface of intermediate transfer belt 2, is arranged.

The surface of the photoconductor 3Y is uniformly charged by the charging unit 4 and a latent electrostatic image is formed on the photoconductor 3Y based on the image information from the image scanning section. The latent electrostatic image is developed to a visible image as a toner image by the image developing unit 6Y which houses a yellow toner and the toner image is primary transferred onto the intermediate transfer belt 2 by the primary transfer unit 7Y to which a predetermined bias is applied. In the case of the other photoconductors 3M, 3C, and 3B, which corresponds to different color from that of the photoconductor 3Y, an image is formed in the same way, and toner images with each color respectively, are transferred onto the intermediate transfer belt 2 in order and are superimposed.

The residual toner on the photoconductor 3 after transfer is removed by the cleaning unit 8, and after transfer, the electric potential of the photoconductor 3 is initialized by a discharge lamp (not shown) to be ready for next image forming process.

In the vicinity of the driving roller 9, an image-fixing apparatus 12 is arranged. In the image-fixing apparatus 12, a transferred-and-fixing belt 13 as a transfer-and-fixing member onto which an unfixed toner image as the image on the intermediate transfer belt 2, is transferred; a fixing roller 15 via the transferred-and-fixing belt 13; and a pressure roller 14 forms a nip N. The transferred-and-fixing belt 13 comprises a heat generating layer and a release layer coated on the surface. Further, the transferred-and-fixing belt 13 is provided with an induction heat source 20 as a heating unit which heats the image on the transferred-and-fixing belt 13. The pressure roller 14 comprises a cored bar 14a and an elastic layer 14b such as a rubber.

The paper feeding section 1B comprises a paper feeding tray 16, a paper feeding roller 17, a conveying-roller pair 18, and a resist roller pair 19. The paper feeding tray 16 houses papers P as recording media on board. The paper feeding roller 17 feeds a paper by separating the papers P in the paper feeding tray 16 one by one in order from the uppermost one. The conveying-roller pair 18 conveys fed papers P. The paper P is stopped at a moment at the resist roller pair 19, disarrangement of the paper is adjusted, and then the paper is sent out to the nip N while adjusting a timing so that a predetermined position of the paper in the conveying direction contacts the transferred-and-fixing belt 13 at the point where the image thereon starts.

Bias (including AC or overlapped pulse) is applied to the driving roller 9 by a bias applying unit (not shown) and the toner image T which has been primary transferred on the intermediate transfer belt 2 from the photoconductors 3Y, 3M, 3C, and/or 3B is secondarily transferred to the fixing belt 13 by electrostatic force.

The toner image T, which has been transferred on the transferred-and-fixing belt 13 from the intermediate transfer belt 2, win be heated on the transferred-and-fixing belt 13 singly until it is fixed to the paper P at the nip N.

In this aspect, since a process during which the toner T alone is preheated is sufficiently achieved, it is possible to make the heating temperature lower compared to a conventional method in which the toner T and the paper P are heated simultaneously. As a result of experiment, it was confirmed that even if the temperature of the transferred-and-fixing belt 13 was a low temperature of 80° C. to 120° C., sufficient image quality could be obtained.

This aspect enables a low temperature fixing and a shorter warm-up time and enhances saving of energy. Further, heat transfer to an intermediate transfer member can be reduced, and thus durability can be improved. Furthermore, the low temperature fixing enables decreased temperature of the intermediate transfer member and deterioration of the intermediate transfer member due to heat can be restrained.

As mentioned above, the image-fixing apparatus 12 according to this aspect itself has function of receiving an unfixed toner image. While a conventional image-fixing apparatus only heat and/or pressure a sheet retaining the unfixed toner image, image-fixing apparatus 12 according to this aspect is positioned as “transfer-type image-fixing apparatus”.

Next, image-fixing apparatus 30 according to another aspect of the invention will be described with reference to FIG. 3. The image-fixing apparatus 30 is intended to improve the rate of transfer of toner from the intermediate transfer belt 2 to the transferred-and-fixing belt 13. In this aspect, the driving roller 9 arranged on the side of the intermediate transfer belt 2 opposite to the transferred-and-fixing belt 13 serves as a bias roller 21 as a bias applying unit which applies a bias to the intermediate transfer belt 2.

Bias having the same polarity as the toner image T (present bias) is applied to this bias roller 21 so that an electric field allowing a toner to be electrostatically adsorbed to the transferred-and-fixing belt in a transfer nip, is generated, thereby providing the toner with an electrostatically repulsive force.

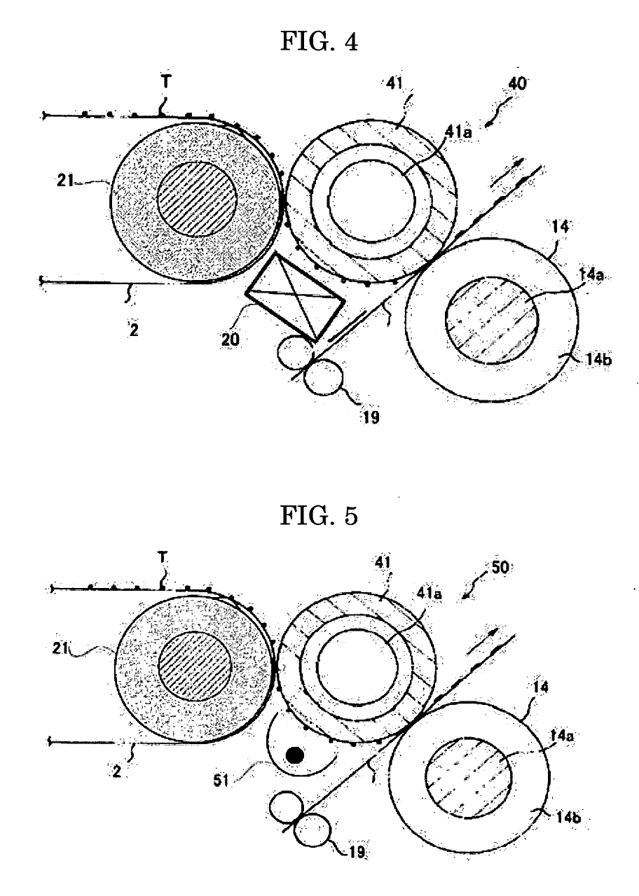

FIG. 4 is a modified aspect of the image-fixing apparatus of FIG. 3. An image-fixing apparatus 40 according to this aspect is provided with a transferred-and-fixing roller 41 instead of the fixing belt of the image-fixing apparatus of FIG. 3.

FIG. 5 is another modified aspect of the image-fixing apparatus of FIG. 3. An image-fixing apparatus 50 according to this aspect is provided with a radiation heat source 51 such as a halogen heater, as a heating unit instead of an induction heat source according to the aforementioned aspect. The radiation heat source 51 is arranged outside the transferred-and-fixing roller 41 and heats the transferred-and-fixing roller 41. In the invention, as a heat source of the image-fixing apparatus, a radiation heating unit may be used as in this aspect other than an induction heating unit.

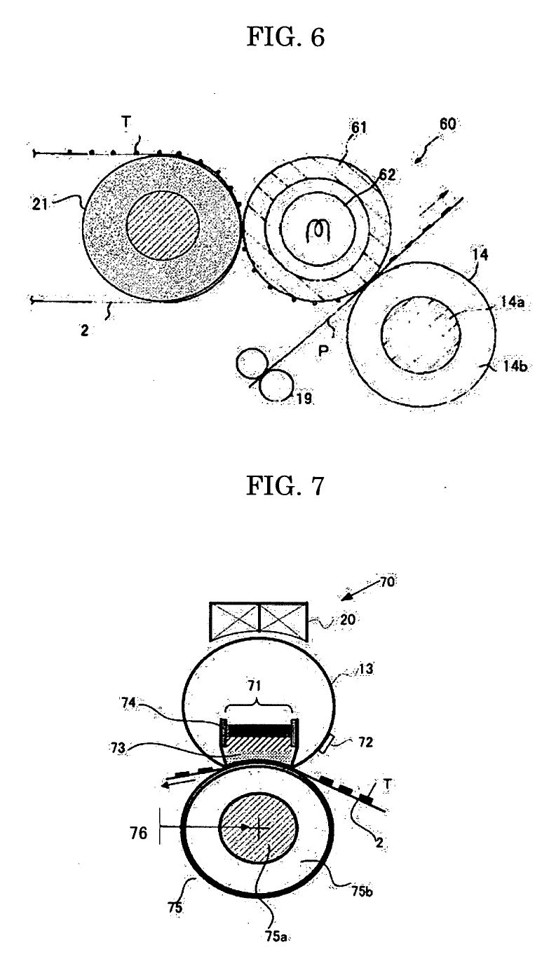

FIG. 6 is another modified aspect of the image-fixing apparatus of FIG. 3. An image-fixing apparatus 60 according to this aspect is provided with a radiation heat source 62 such as a halogen heater, as a heating unit instead of the induction heat source according to the aforementioned aspect. The radiation heat source 62 is arranged in the transferred-and-fixing roller 61 and heats the transferred-and-fixing roller 61.

Next, an image-fixing apparatus according to another aspect of the invention will be described. FIG. 7 shows an image-fixing apparatus 70 according to another aspect of the invention. In the image-fixing apparatus 70 according to this aspect, heating is conducted by an induction heat source 20. A fixing member 71 held inside the transferred-and-fixing belt 13 comprises a frame body 74 and an elastic member 73 composed of a foam. A pressure roller 75 comprises a cored bar 75a and a covering member 75b composed of a hard foam. Note that in the figure, reference numbers 72 and 76 represents a temperature sensor and a driving unit of the pressure roller 75.

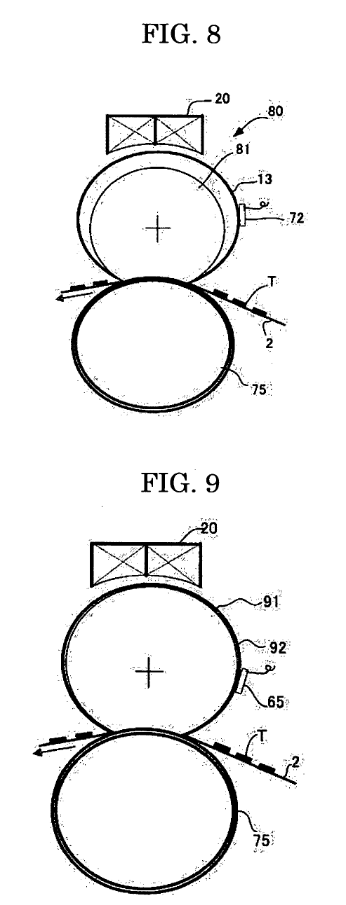

FIG. 8 is a modified aspect of the image-fixing apparatus shown in FIG. 7. In an image-fixing apparatus 80 according to this aspect, the fixing member held inside the transferred-and-fixing belt shown in FIG. 7 is replaced by a roller composed of an elastic foam.

FIG. 9 is another modified aspect of the image-fixing apparatus shown in FIG. 7. An image-fixing apparatus according to this aspect comprises a fixing roller 91 composed of an elastic foam, and a fixing belt 92 instead of the fixing member held inside the transferred-and-fixing belt shown in FIG. 7.

### EXAMPLES

The invention will be described more specifically with reference to the following examples, but the invention is not limited to these examples. Wherever “parts” are mentioned, they are invariably based on weight.

### Example 1 of Toner Preparation

| | |
|---|---|
| Polyester resin (Polyester which was obtained | 100 parts by weight |
| by condensing polyethyleneglycol, propylene oxide | |
| (PO) adducts of bisphenol A terephthalic acid, | |
| fumaric acid, and trimellitic acid) | |
| Carbon black (#44, manufactured by Mitsubishi | 8 parts by weight |
| Chemical Corporation) | |
| Carnauba wax | 5 parts by weight |
| Metallic salt compound of salicylic acid | 3 parts by weight |

Mixture having the above composition was fully stirred and mixed in HENSCHEL MIXER, then heated and fused with a roll mill at a temperature of 130° C. to 140° C. for about 30 minutes and cooled to a room temperature. Thereafter, thus-obtained mixture was grinded and classified to thereby prepare a toner with a weight average particle diameter of 6.2 μm (Toner 1). This toner had a ½ flown-out temperature of 122.3° C. and a storage elastic modulus (G′) at 190° C. of 500 Pa. The toner also had a peak molecular weight of 8,500. 100 parts by weight of silicone resin solution (KR251, manufactured by Shin-Etsu silicones) and 100 parts by weight of toluene were dispersed with a homomixer to prepare a solution for forming a coating layer, and this solution for forming a coating layer was coated on the surface of 1,000 parts by weight of spherical ferrite with an average particle diameter of 50 μm by means of a coating apparatus of fluidized bed type to thereby obtain a carrier in which a coating layer is formed. To 3 parts by weight of this toner, 97 parts by weight of the thus-obtained carrier was mixed in a ball mill to obtain a developer (developer 1).

### Example 2 of Toner Preparation

| | |
|---|---|
| Polyester resin (Polyester which was obtained | 100 parts by weight |
| by condensing polyethyleneglycol, ethylene oxide | |
| (EO) adducts of bisphenol A terephthalic acid, | |
| and trimellitic acid) | |
| Carbon black (#44, manufactured by Mitsubishi | 8 parts by weight |
| Chemical Corporation) | |
| Esters wax | 5 parts by weight |
| Metallic salt compound of salicylic acid | 3 parts by weight |

Mixture having the above composition was fully stirred and mixed in HENSCHEL MIXER, then heated and fused with a roll mill at a temperature of 130° C. to 140° C. for about 30 minutes and cooled to a room temperature. Thereafter, thus-obtained mixture was grinded and classified to thereby prepare a toner with a weight average particle diameter of 5.2 μm (Toner 2). This toner had a ½ flown-out temperature of 119.5° C. and a storage elastic modulus (G′) at 190° C. of 1,025 Pa. The toner also had a peak molecular weight of 8,800. 100 parts by weight of silicone resin solution (KR251, manufactured by Shin-Etsu silicones) and 100 parts by weight of toluene were dispersed with a homomixer to prepare a solution for forming a coating layer, and this solution for forming a coating layer was coated on the surface of 1,000 parts by weight of spherical ferrite with an average particle diameter of 50 μm by means of a coating apparatus of fluidized bed type to thereby obtain a carrier in which a coating layer is formed. To 3 parts by weight of this toner, 97 parts by weight of the thus-obtained carrier was mixed in a ball mill to obtain a developer (developer 2).

### Example 3 of Toner Preparation

| | |
|---|---|
| Polyester resin (Polyester which was obtained by | 100 parts by weight |
| condensing EO and PO adducts of bisphenol A, | |
| fumaric acid, and trimellitic acid) | |
| Carbon black (#44, manufactured by Mitsubishi | 8 parts by weight |
| Chemical Corporation) | |
| Carnauba wax | 5 parts by weight |
| Metallic salt compound of salicylic acid | 3 parts by weight |

Mixture having the above composition was fully stirred and mixed in HENSCHEL MIXER, then heated and fused with a roll mill at a temperature of 130° C. to 140° C. for about 30 minutes and cooled to a room temperature. Thereafter, thus-obtained mixture was grinded and classified to thereby prepare a toner with a weight average particle diameter of 6.9 μm (Toner 3). This toner had a ½ flown-out temperature of 138° C. and a storage elastic modulus (G′) at 190° C. of 2,055 Pa. The toner also had a peak molecular weight of 9,500. 100 parts by weight of silicone resin solution (KR251, manufactured by Shin-Etsu silicones) and 100 parts by weight of toluene were dispersed with a homomixer to prepare a solution for forming a coating layer, and this solution for forming a coating layer was coated on the surface of 1,000 parts by weight of spherical ferrite with an average particle diameter of 50 μm by means of a coating apparatus of fluidized bed type to thereby obtain a carrier in which a coating layer is formed. To 3 parts by weight of this toner, 97 parts by weight of the thus-obtained carrier was mixed in a ball mill to obtain a developer (developer 3).

### Comparative Example 1 of Toner Preparation (Example of Toner Having Less than ½ Flow-Out Beginning Temperature)

| | |
|---|---|
| Polyester resin (Polyester which was obtained by | 100 parts by weight |
| condensing polyethyleneglycol, EO adducts of | |
| bisphenol A, terephthalic acid, and fumaric acid) | |
| Carbon black (#44, manufactured by Mitsubishi | 8 parts by weight |
| Chemical Corporation) | |
| Carnauba wax | 5 parts by weight |
| Metallic salt compound of salicylic acid | 3 parts by weight |

Mixture having the above composition was fully stirred and mixed in HENSCHEL MIXER, then heated and fused with a roll mill at a temperature of 130° C. to 140° C. for about 30 minutes and cooled to a room temperature. Thereafter, thus-obtained mixture was grinded and classified to thereby prepare a toner with a weight average particle diameter of 6.0 μm (Comparative Toner 1). This toner had a ½ flow-out beginning temperature of 110.8° C. and a storage elastic modulus (G′) at 190° C. of 350 Pa. The toner also had a peak molecular weight of 4,200. 100 parts by weight of silicone resin solution (KR251, manufactured by Shin-Etsu silicones) and 100 parts by weight of toluene were dispersed with a homomixer to prepare a solution for forming a coating layer, and this solution for forming a coating layer was coated on the surface of 1,000 parts by weight of spherical ferrite with an average particle diameter of 50 μm by means of a coating apparatus of fluidized bed type to thereby obtain a carrier in which a coating layer is formed. To 3 parts by weight of this toner, 97 parts by weight of the thus-obtained carrier was mixed in a ball mill to obtain a developer (Comparative developer 1).

### Comparative Example 2 of Toner Preparation (Example of Toner Having More than Flow-Out Beginning Temperature)

| | |
|---|---|
| Polyester resin (Polyester which was obtained by | 100 parts by weight |
| condensing PO adducts of bisphenol A, terephthalic | |
| acid, and fumaric acid) | |
| Carbon black (#44, manufactured by Mitsubishi | 8 parts by weight |
| Chemical Corporation) | |
| Carnauba wax | 5 parts by weight |
| Metallic salt compound of salicylic acid | 3 parts by weight |

Mixture having the above composition was fully stirred and mixed in HENSCHEL MIXER, then heated and fused with a roll mill at a temperature of 130° C. to 140° C. for about 30 minutes and cooled to a room temperature. Thereafter, thus-obtained mixture was grinded and classified to thereby prepare a toner with a weight average particle diameter of 6.0 μm (Comparative Toner 2). This toner had a ½ flown-out temperature of 152.5° C. and a storage elastic modulus (G′) at 190° C. of 650 Pa. The toner also had a peak molecular weight of 10,500. 100 parts by weight of silicone resin solution (KR251, manufactured by Shin-Etsu silicones) and 100 parts by weight of toluene were dispersed with a homomixer to prepare a solution for forming a coating layer, and this solution for forming a coating layer was coated on the surface of 1,000 parts by weight of spherical ferrite with an average particle diameter of 50 μm by means of a coating apparatus of fluidized bed type to thereby obtain a carrier in which a coating layer is formed. To 3 parts by weight of this toner, 97 parts by weight of the thus-obtained carrier was mixed in a ball mill obtain a developer (Comparative developer 2).

### Comparative Example 3 of Toner Preparation (Example of Toner Having a Storage Elastic Modulus (G′) at 190° C. Less than 200 Pa)

| | |
|---|---|
| Polyester resin (Polyester which was obtained by | 100 parts by weight |
| condensing polyethyleneglycol, EO adducts of | |
| bisphenol A, and fumaric acid) | |
| Carbon black (#44, manufactured by Mitsubishi | 8 parts by weight |
| Chemical Corporation) | |
| Carnauba wax | 5 parts by weight |
| Metallic salt compound of salicylic acid | 3 parts by weight |

Mixture having the above composition was fully stirred and mixed in HENSCHEL MIXER, then heated and fused with a roll mill at a temperature of 130° C. to 140° C. for about 30 minutes and cooled to a room temperature. Thereafter, thus-obtained mixture was grinded and classified to thereby prepare a toner with a weight average particle diameter of 6.0 μm (Comparative Toner 3). This toner had a ½ flow-out beginning temperature of 125.8° C. and a storage elastic modulus (G′) at 190° C. of 120 Pa. The toner also had a peak molecular weight of 5,200. 100 parts by weight of silicone resin solution (KR251, manufactured by Shin-Etsu silicones) and 100 parts by weight of toluene were dispersed with a homomixer to prepare a solution for forming a coating layer, and this solution for forming a coating layer was coated on the surface of 1,000 parts by weight of spherical ferrite with an average particle diameter of 50 μm by means of a coating apparatus of fluidized bed type to thereby obtain a carrier in which a coating layer is formed. To 3 parts by weight of this toner, 97 parts by weight of the thus-obtained carrier was mixed in a ball mill to obtain a developer (Comparative developer 3).

Next, fixing properties of these toners will be evaluated. The fixing properties of toner was determined by lowest fixing temperature. The lowest fixing temperature was measured as follows. A copying test was carried out on Type-6200 Paper (trade name, available from Ricoh Company., Ltd.) by the image-fixing apparatus 100 shown in FIG. 10. Note that as the configuration of the fixing belt, the aforementioned “h” was used. The lowest fixing temperature was defined as a temperature of the fixing roller at which a survival rate of the image density was 70% or more after rubbing the fixed image with a pat. Further, when the fixing temperature is raised, so-called hot offset phenomenon occurs, i.e., toner is fused excessively, thereby all toners remain on the fixing belt without being fixed on a transfer member such as paper and the remaining toner adheres to non-image region. Fixing temperature range refers to the temperature range from the lowest fixing temperature to the upper limit temperature at which hot offset phenomenon does not occur.

The lowest fixing temperature is preferably 140° C. or less from practical use (e.g. influence on the setup of an apparatus), and fixing temperature range is preferably 60° C. or more.

The results of the above-mentioned experiment are shown in Table 2. Note that the above-mentioned image-fixing apparatus 100 (FIG. 10) was used for this measurement.

TABLE 2

| | Lowest fixing | Hot offset generating | |
|---|---|---|---|
| Toner | temperature (° C.) | temperature (° C.) | Evaluation |
| Toner 1 | 130 | 230 | Good |
| Toner 2 | 135 | 230 | Good |
| Toner 3 | 125 | 200 | Good |
| Comp. Toner 1 | 125 | 140 | Poor |
| Comp. Toner 2 | 165 | 210 | Poor |
| Comp. Toner 3 | 130 | 150 | Poor |

In the combinations of the toners 1, 2, and 3, and the image-fixing apparatus of the present invention, temperature range capable of fixing is 75° C. or more, achieving sufficient synergic effect.

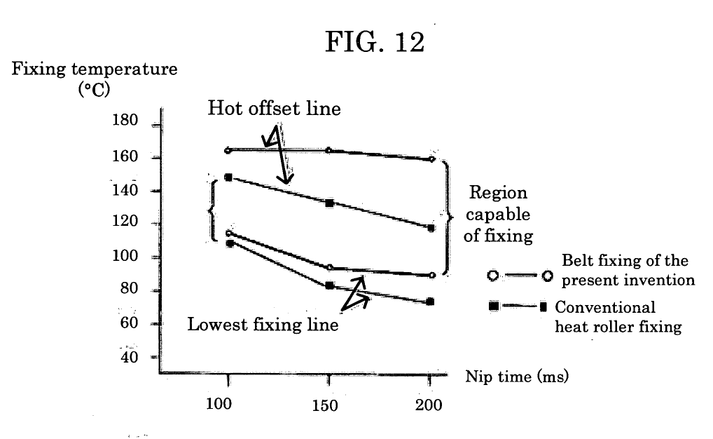

Further, fixing characteristics were compared using the image-fixing apparatus 100 of FIG. 10 and a conventional heat roller image-fixing apparatus in which a fixing roller and a heating roller forms a nip, and using the toner 1. As shown in FIG. 12, even if the toner of the invention is used, the conventional heat roller image-fixing apparatus had a temperature range capable of fixing of about 40° C. to about 50° C.

While the invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image-fixing apparatus comprising:
a fixing belt;
a fixing member;
a pressure member; and
a heating source,
wherein the fixing belt is heated by the heating source,
wherein the fixing member is brought into pressure contact with the pressure member via the fixing belt to form a nip and a paper carrying an unfixed toner is allowed to pass through the nip, thereby fixing the unfixed toner on the paper,
wherein the toner to be used comprises a binder resin, a colorant, and a releasing agent, and
wherein the toner has a ½ flown-out temperature of 115° C. to 145° C. and has a storage elastic modulus (G′) at 190° C. of 200 Pa or more.

2. The image-fixing apparatus according to claim 1, wherein the heating source is one of an induction heating unit and a radiation heating unit.

3. The image-fixing apparatus according to claim 1, wherein the fixing belt having a low thermal capacity has a thermal capacity of 0.019 J/K per square centimeter of: fixing belt to 0.077 J/K per square centimeter of fixing belt.

4. The image-fixing apparatus according to claim 1, wherein the fixing belt comprises a heat generating layer and a release layer, and wherein the heat generating layer of the fixing belt has a thickness of 40 μm or less and the release layer of the fixing belt has a thickness of 10 μm or more.

5. The image-fixing apparatus according to claim 1, wherein the release layer comprises a fluorine resin material.

6. The image-fixing apparatus according to claim 1, wherein the toner comprises, as a resin component, a resin having a THF insoluble content in the resin component of 10% or more.

7. The image-fixing apparatus according to claim 1, wherein the toner has a peak molecular weight of 8,500 to 10,000.

8. The image-fixing apparatus according to claim 1, wherein the toner comprises one of a free fatty acid-removed carnauba wax, montan wax, oxidized rice wax, and ester wax, as a releasing agent.

9. The image-fixing apparatus according to claim 1, wherein the fixing member is a fixing roller and the pressure member is a pressure roller,
wherein at least one of the fixing roller and the pressure roller has a heat insulating structure, and
wherein the pressure roller has rigidity, the hardness of the pressure roller is larger than that of the fixing roller, and the fixing belt rolls by transmission of the driving from the pressure roller.

10. An image-fixing apparatus comprising:
a transfer fixing member;
a pressure member; and
a heating source,
wherein the transfer fixing member carrying an toner image is heated by the heating source,
wherein the transfer fixing member is brought into pressure contact with the pressure member to form a nip and a paper is allowed to pass through the nip, thereby fixing a toner on the paper,
wherein the toner to be used comprises a binder resin, a colorant, and a releasing agent, and
wherein the toner has a ½ flown-out temperature of 115° C. to 145° C. and has a storage elastic modulus (G′) at 190° C. of 200 Pa or more.

11. The image-fixing apparatus according to claim 10, wherein the transfer fixing member comprises a transfer fixing belt and a fixing roller, and the transfer fixing belt carrying an toner image is heat by the heating source, the transfer fixing roller is brought into pressure contact with the pressure member via the transfer fixing belt to form a nip and a paper is allowed to pass through the nip, thereby fixing a toner on the paper,

12. The image-fixing apparatus according to claim 11, wherein the fixing belt comprises a heat generating layer and a release layer, and has a low thermal capacity.

13. The image-fixing apparatus according to claim 10, wherein the transfer fixing member is a transfer fixing roller.

14. The image-fixing apparatus according to claim 10, wherein the toner comprises, as a resin component, a resin having a THF insoluble content in the resin component of 10% or more.

15. The image-fixing apparatus according to claim 10, wherein the toner has a peak molecular weight of 8,500 to 10,000.

16. The image-fixing apparatus according to claim 10, wherein the toner comprises one of a free fatty acid-removed carnauba wax, montan wax, oxidized rice wax, and ester wax, as a releasing agent.

17. The image-forming apparatus comprising an image-fixing apparatus, wherein the image-fixing apparatus comprises:
a fixing belt;
a fixing member;
a pressure member; and
a heating source,
wherein the fixing belt is heated by the heating source,
wherein the fixing member is brought into pressure contact with the pressure member via the fixing belt to form a nip and a paper carrying an unfixed toner is allowed to pass through the nip, thereby fixing the unfixed toner on the paper,
wherein the toner to be used comprises a binder resin, a colorant, and a releasing agent, and
wherein the toner has a ½ flown-out temperature of 115° C. to 145° C. and has a storage elastic modulus (G′) at 190° C. of 200 Pa or more.

18. The image-forming apparatus comprising an image-fixing apparatus, wherein the image-fixing apparatus comprises:
a transfer fixing member;
a pressure member; and
a heating source,
wherein the transfer fixing member carrying an toner image is heated by the heating source,
wherein the transfer fixing member is brought into pressure contact with the pressure member to form a nip and a paper is allowed to pass through the nip, thereby fixing a toner on the paper,
wherein the toner to be used comprises a binder resin, a colorant, and a releasing agent, and
wherein the toner has a ½ flown-out temperature of 115° C. to 145° C. and has a storage elastic modulus (G′) at 190° C. of 200 Pa or more.
